(19) United States
(12) Patent Application Publication
(10) Pub. No.: US 2003/0157945 A1
(43) Pub. Date: Aug. 21, 2003

(54) Method and apparatus for delivering server-originated information during a dormant packet data session

(76) Inventors: An Mei Chen, San Diego, CA (US); Ravinder Chandok, Poway, CA (US); Eric C. Rosen, Solana Beach, CA (US)

Correspondence Address: Qualcomm Incorporated, Patents Department, 5775 Morehouse Drive, San Diego, CA, 92121-1714, US

(21) Appl. No.: 10/080,951

(22) Filed: Feb. 21, 2002

(51) Int. Cl. H04Q 7/20

(52) U.S. Cl. 455/458; 455/456

(57) ABSTRACT

A method and apparatus for delivering information to a dormant target mobile provides for sending the information when no dedicated traffic channel is established. In one embodiment, the method provides for sending the information in short data bursts. Therefore, the disclosed embodiments provide for a significant reduction in the actual total dormancy wakeup time by exchanging group call signaling even when the target mobiles are dormant and no traffic channel is active.

### FIELD

The present invention relates to point to multi-point communications systems. More specifically, the present invention relates to a method and apparatus for delivering server-originated information to a dormant target communication device in a wireless communication network.

### BACKGROUND

When the packet data service in a wireless communications system is active, resources in the infrastructure, e.g., base station transceiver subsystem (BTS), base station controller (BSC), interworking (IWF), and the radio link are actively assigned to a mobile station (MS). After a period of inactivity in the communications system, the user traffic channels may transition to the dormant packet data session to conserve system capacity, reduce service cost, and save battery life. However, transitioning a dormant packet data session back to an active session causes a considerable delay in the system response. Existing wireless communication infrastructures provide limited opportunities for significantly reducing the latency in waking up a dormant packet data session, i.e., the actual latency may not be possibly reduced below the time required to re-establish traffic channels within the dormant packet-data session.

For example, a class of wireless service intended for quick, efficient, one-to-one or one-to-many (group) communication has existed in various forms for many years. In general, these services have been half-duplex, where a user presses a “push-to-talk” (PTT) button on his phone/radio to initiate a call speech. If granted the floor, or talker permission, the user then generally speaks for a few seconds, after which he releases his PTT button, and other speakers can request the floor. Communication is generally from one speaker to a group of listeners, but may be one-to-one. This service has traditionally been used in applications where one person, a “dispatcher,” needs to communicate to a group of people, such as field service personnel or taxi drivers, which is where the “dispatch” name for the service comes from. Similar services have been offered on the Internet and are generally known as “voice chat.”

A key feature of these services is that communication is quick and spontaneous, usually initiated by simply pressing a PTT button, without going through a typical dialing and ringing sequence. Communication in this type of service is generally very short, with individual talk “spurts” being generally on the order of several seconds, and “conversations” lasting possibly a minute or less. The time delay between when the user requests the floor and when he receives a positive or negative confirmation from the server that he has the floor and may begin speaking, which is known as the PTT latency, is a critical parameter for half-duplex group communications systems. As mentioned previously, dispatch systems place a priority on short, quick conversations, which makes the service less effective if the PTT latency becomes large.

There is a need, therefore, for mechanisms to reduce the latency experienced by the talker and total time required to re-establish traffic channels for participating mobiles without negatively impacting system capacity, client battery life, or other resources.

### SUMMARY

The disclosed embodiments provide a novel and improved method and apparatus for delivering information to a dormant communication device in a wireless communication network. In one aspect of the invention, a method for delivering information to a dormant target communication device in a wireless communication system, which includes a base station controller (BSC) and a packet control function (PCF), includes receiving information at the BSC for transmission to a target communication device and broadcasting the information to a plurality of communication devices within a service area of the BSC. In one aspect, the information is sent on a reverse access channel (R-ACH) or on a reverse enhanced access channel (R-EACH) as short data bursts.

In one aspect, a method for delivering information to a dormant target communication device in a wireless communication system, which includes a base station controller (BSC) and a packet control function (PCF), includes receiving information at the BSC for transmission to a target communication device, sending a request to a plurality of communication devices within a service area of the BSC, receiving a response from a communication device in the service area, and sending the information to the communication device that has responded to the request.

In one aspect, a method for delivering information to a dormant target communication device in a wireless communication system, which includes a plurality of base station controllers (BSCs) in communication with a packet control function (PCF), includes receiving a request at one of the plurality of BSCs to send information to a target communication device, determining if the BSC has location information about the target communication device, and transmitting the information to the target communication device if the BSC has the location information. The method further includes transmitting the information to other BSCs if the BSC does not have location information for the target communication device so that one of the other BSCs that has location information for the target communication device transmits the information to the target communication device. The method further includes broadcasting the information to all communication devices if none of the BSCs has location information for the target communication device.

In one aspect, a method for delivering information to a dormant target communication device in a wireless communication system, which includes a mobile station controller (MSC) and a plurality of base station controllers (BSCs) in communication with a packet control function (PCF), includes receiving an application data delivery service (ADDS) page at one of the plurality of BSCs for transmitting information to the target communication device, buffering the information at the BSC, sending a request to a plurality of communication devices within a service area of the BSC, receiving a response from a communication device in the service area, and sending the information to the communication device that has responded to the request.

In one aspect, an apparatus for delivering information to a dormant target communication device in a wireless communication system includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description set forth below when taken in conjunction with the drawings in which like reference characters identify correspondingly throughout and wherein:

FIG. 1 illustrates a group communications system;

FIG. 2 illustrates how several communication devices interact with a group call server;

FIG. 3 illustrates an exemplary call-setup process according to one embodiment;

FIG. 4 illustrates call-signaling details for a network-initiated information delivery process according to one embodiment;

FIG. 5 illustrates an exemplary process for buffering location information for mobile stations according to one embodiment;

FIG. 6 illustrates an exemplary configuration for a group communication network according to a first embodiment;

FIG. 7 illustrates an exemplary configuration for a group communication network according to a second embodiment; and

FIG. 8 illustrates an exemplary network-initiated information delivery process according to one embodiment.

### DETAILED DESCRIPTION

Before one embodiment of the invention is explained in detail, it is to be understood that the invention is not limited in its application to the details of the construction and the arrangement of the components set forth in the following description or illustrated in the drawings. The invention is capable of being implemented in other embodiments and are carried out in various ways. Also, it is understood that the phraseology and terminology used herein is for purpose of description and should not be regarded as limiting.

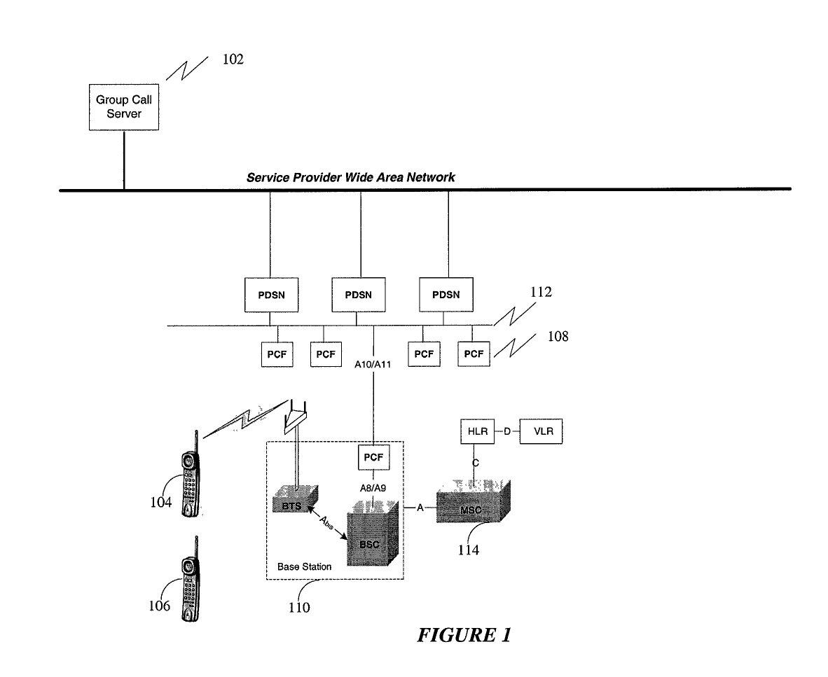

FIG. 1 illustrates an exemplary functional block diagram of a group communication system 100, for implementing one embodiment of the present invention. The group communication system 100 is also known as a push-to-talk (PTT) system, a net broadcast service (NBS), a dispatch system, or a point-to-multi-point communication system. In one embodiment, the group communication system 100 includes a group call server 102, which may be deployed in either a centralized deployment or a regionalized deployment.

The group communication devices (clients) 104 and 106, which may be deployed on a cdma2000 handset, for example, may request a packet data session using a data service option and use this session to register its IP address with the application server to perform group call initiations. In one embodiment, group call server 102 is connected to the service provider's packet data service nodes (PDSNs). Clients 104 and 106, upon requesting a packet data session from the wireless infrastructure, may have IP connectivity to the group call server 102 through the PDSNs. The PDSNs provide interfaces between transmission of the data in the fixed network and the transmission of the data over the air interface. Each PDSN may interface to a base station controller (BSC) through a packet control function (PCF) 108, which may be co-located with the BSC within the base station (BS) 110, and the network 112.

The packet data service may fall in one of several states, e.g., active or connected state, dormant state, and null or inactive state. In the active or connected state, a physical traffic channel exists between the mobile station (MS) and the BS or BSC, and either side may send data. In the dormant state, no physical traffic channel exists between the MS and the BSC, but the PPP link between the MS and the PDSN is maintained. In the null or inactive state, there is no physical traffic channel between the MS and the BSC and no PPP link between the MS and the PDSN.

Upon power-up, clients 104 and 106 may request a packet data session using the data service option. As part of the establishment of the packet data session, each client may be assigned an IP address. The client 104 and 106 may perform a registration process to notify the group call server 102 of their location information, e.g., IP addresses. The registration may be performed using an IP protocol, such as session initiation protocol (SIP) over user datagram protocol (UDP). The IP address of the clients may be used to contact the client when the user is invited into a group call.

Once a group call is established, clients 104 and 106 and group call server 102 may exchange media and signaling messages. In one embodiment, the media may be sent between the call participants and group call server 102 using real-time protocol (RTP) over UDP. The signaling messages may be also signaling protocol over UDP.

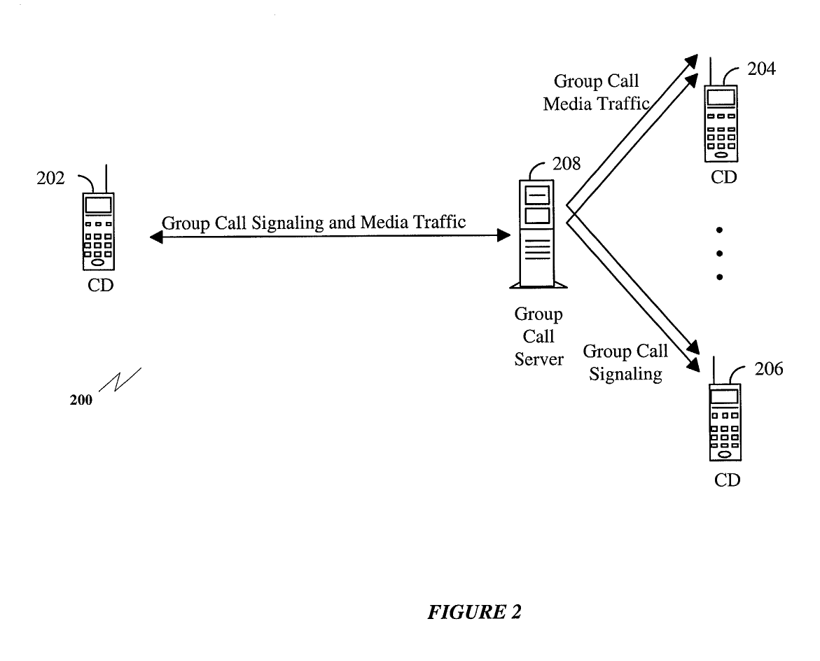

FIG. 2 illustrates an exemplary group 200 for showing how communication devices 202, 204, and 206 interact with a group call server 208. Multiple group call servers may be deployed as desired for large-scale groups. In FIG. 2, CD 202 has permission to transmit media to other members of the group. In this case, CD 202 is known as the talker and transmits media over a channel. When CD 202 is designated as the talker, the remaining participants, CD 204 and CD 206, may not have permission to transmit media to the group. Accordingly, CD 204 and CD 206 are designated as listeners. As described above, CDs 202, 204, and 206 are connected to group call server 208, using at least one channel. In one embodiment, the channel may include a session initiation protocol (SIP) channel, a media-signaling channel, and a media traffic channel.

The group communication system 100 performs several different functions in order to operate the group services. The functions relating to user experiences include registration, call initiation, call termination, sending alerts, late join, talker arbitration, adding users, removing members, un-registering, addressing, and authentication. The functions relating to system preparation and operation include administration and provisioning, scalability, and reliability. These functions are described in detail in the copending patent application entitled, “A Communication Device for Defining a Group in a Group Communication Network,” attorney docket No. PA020042, which is assigned to the same assignee and incorporated herein in its entirety.

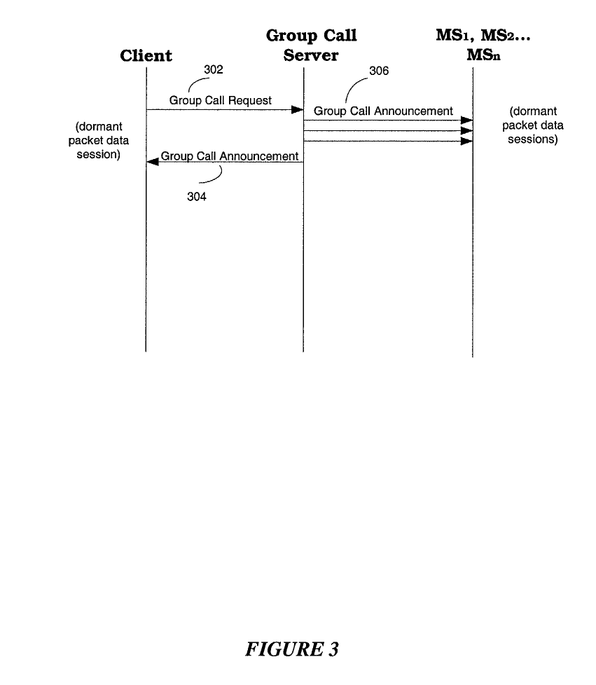

FIG. 3 illustrates an exemplary message flow for starting a group call. The user may be in a dormant packet data session when he or she desires to initiate a group call. The user may select one or more target users, one or more pre-defined groups, or a combination of the two and may depress the push-to-talk (PTT) button. The client may then send a group call request 302 to group call server 102 to setup the group call, regardless of whether the mobile station has a dedicated traffic channel or not, as will be discussed in more detail later. After the request is sent, if the mobile station's packet data session is dormant, the client may initiate the process of re-establishing dedicated traffic channels and preparing the packet data session for media activity. The client may buffer speech input received from the originator for some period of time.

When the group call server 102 receives the request, it may expand the pre-defined groups, if any is specified in the request, into target user member lists. Then, the group call server may retrieve the target users' location information. At this point, the group call server may also determine if the desired group is already running in the system. FIG. 3 shows a scenario in which the group is not already running.

After the group call server locates at least one of the target users, it may send a response 304 back to the client indicating the group call is being set up. At this point, the client may optimistically grant the originator's request to talk and start buffering the received media. The group call server may use the locations of the target users to send out announcements 306 to the target listeners. Sending the announcements may trigger the packet data sessions of the target listeners to come out of dormancy and re-establish their traffic channels.

The “instant response” relates to the response time it takes for the application server to respond to a PTT or call setup request. The goal for responding to any PTT request, including group call setup requests, is to consistently respond to the request in a predetermined time period, e.g., one second or less. In many cases, when a user requests to setup a group call, the user's packet data session is dormant and no dedicated traffic channel exists. Re-establishing dedicated traffic channels may take considerable time. Therefore, communication to the application server may be accomplished through some other means.

In one embodiment, the group communication system 100 supports both the chat-room model and the ad-hoc model. In the chat-room model, the groups are pre-defined, which may be stored on the dispatch server. The pre-defined groups may be public, implying that the group has an open member list, i.e. any dispatch user is a potential participant. In the chat-room model, the call is started when the first person opts to join the chat-room, and the call remains running, with server resources assigned to the call, regardless of talk activity, for a pre-determined amount of time, which may be configured by the service provider. Users specifically request to join and leave these types of calls. During periods of talk inactivity, each call is brought into a group dormant state, as will be discussed later, until a user requests permission to talk. When operating in the chat-room model in the group communications system 100, a group of communication device users, individually known as net members, communicate with one another using a communication device assigned to each net member. The term “net” denotes a group of communication device users authorized to communicate with each other.

In the ad-hoc model, groups may be defined in real-time and have a closed member list associated with them. A closed member list may specify which users are allowed to participate in the group, may not be available to users outside of the closed member list, and may only exist for the life of the call. Ad-hoc group definitions may not be stored anywhere; they may be used to establish the call and released after the call has ended. An ad-hoc group may be formed when an originating user selects one or more target users and generates a request, which is sent to a server to start the call. The target users may be sent a notification that they have been included in a group and may automatically be joined into the associated call, i.e., no user action may be required. When an ad-hoc call becomes inactive, the application servers may “tear down” the call and free the resources assigned to it, including the group definition used to start the call.

PTT Latency

In one embodiment, when the packet data service is active, resources in the infrastructure, e.g., base station transceiver subsystem (BTS), base station controller (BSC), packet control function (PCF), and the radio link are actively assigned to the mobile station (MS). In an IP-based VoIP dispatch service, while there is an active conversation going on between group participants, the packet data connection for each user remains active. However, after a period of inactivity, i.e., “hang time,” in the wireless communications the user traffic channels may transition to the dormant state.

The transition to the dormant state conserves system capacity and reduces service cost and battery drain. While packet data sessions are active, even if no data packets are being exchanged, radio frequency (RF) energy may still be transmitted by the mobile phones, albeit at a low level, to maintain synchronization and power control with the base station. These transmissions may cause a significant power drain on the phone. In the dormant state, however, the phone may not perform any RF transmission. To conserve phone power and extend battery life, the hang time may be set to transition the phone to dormant mode after extended periods of no data transmission.

In the exemplary case of group call services, while the packet data service is active for all users, PTT requests, which may be IP datagrams sent between the client CD and the group call server, have very low latency. However, if the user channels have previously transitioned to the dormant state, the PTT latency may be much longer. During packet data dormancy, state information associated with the packet data session, which may include the mobile IP address, may be maintained. However, state information associated with layers below PPP, such as the physical traffic layers, may be released and/or de-allocated.

In some infrastructures, to wake up a dormant packet data connection, the traffic channel must be reallocated, the resources must be reassigned, and the radio link protocol (RLP) layer must be reinitialized. The effect of this is that after a talk group has not talked for a while, when a user presses his PTT button to request the floor, the PTT latency for the first talk spurt is generally much longer than for subsequent talk spurts. While this is relatively infrequent, it can affect the utility of the service, and should be minimized.

To reduce the PTT latency, in one embodiment, the group call signaling, such as the floor-control requests, floor-control responses, and dormancy wakeup messages, may be transmitted on some available common channels, without waiting for dedicated traffic channels to be re-established. Such common channels may be always available, regardless of the state of the mobiles, and may not require being requested and reassigned each time a user wishes to initiate a group call. Therefore, the group call signaling may be exchanged even when mobiles are dormant, which may provide a means to re-establish dedicated traffic channels for the talker and listener mobiles in parallel.

In one embodiment, the calling mobile may send a floor-control request to the wireless infrastructure over some available reverse common channels, such as reverse access channel and reverse enhanced access channel. The calling mobile may also receive a response to the floor-control request on some available forward common channels, such as forward paging channel and forward common control channel. In one embodiment, the dormant listener mobiles may receive dormancy wakeup messages on some available forward common channels, such as forward paging channel and forward common control channel.

Short Data Burst Call-Signaling Messages

In one embodiment, a significant reduction in the actual total dormancy wakeup time may be achieved through the use of the short data burst (SDB) messages, as provided in “TIA/EIA/IS2000 Standards for cdma2000 Spread Spectrum Systems,” hereinafter referred to as “the cdma2000 standard,” for example. In one embodiment, SDB messages may be sent over both dedicated physical channels, such as the forward fundamental channel (FCH) or forward dedicated common control channel (F-DCCH), or common physical channels, such as the reverse access channel (R-ACH), reverse enhanced access channel (R-EACH), forward common control channel (F-CCCH), or paging channel (PCH). The SDB messages may be transported by radio burst protocol (RBP), which maps the messages onto an appropriate and available physical layer channel. Because SDB messages may carry arbitrary IP traffic and may be sent over common physical channels, SDB messages provide a mechanism to exchange group call signaling when a calling client's mobile has no dedicated traffic channels.

Mobile-Originated Call-Signaling Messages

In one embodiment, media-signaling messages may carry IP datagrams over the reverse link or mobile-originated link. A client mobile station may signal the group call server quickly whenever the user requests the floor and a dedicated reverse traffic channel is not immediately available. Assuming the client mobile station has released all dedicated traffic channels, the client mobile station may immediately forward the floor-control request over a reverse common channel of a wireless infrastructure, which may relay the request to the group call server. For example, either the reverse access channel or the reverse enhanced access channel may be used to send such messages when a dedicated reverse channel is not available. In one embodiment, the client mobile station may transmit a floor-request message to the group call server as an SDB Message.

Network-Originated Call-Signaling Messages

In one embodiment, after receiving the floor-control request, the group call server may burst media signaling messages to a group of target participants (listeners) and trigger the reestablishment of participants' (listeners') traffic channels. In one embodiment, when the packet control function (PCF) receives a small amount of information, e.g., packet data, from the packet data serving node (PDSN), which may be destined for a mobile with the dormant packet data service instance, the PCF may choose to send the information to the base station controller (BSC) in a special form. In one embodiment, the special form includes short data burst (SDB) format, as specified in the TIA/EIA/IS-707-A-2, “Data Service Option Standard for Spread Spectrum Systems”, Addendum 2, dated June 2000 (IS-707-A-2). The TIA/EIA/IS-2001-A, “Interoperability Specification (IOS) for cdma2000 Access Network Interfaces,” dated August 2001, (IS-2001-A) standard defines several options for the BSC to deliver the SDB to the mobile.

According to the IS-2001-A standard, for example, when a small amount of data destined for a dormant packet data service instance on a mobile is received at the PCF, the PCF may choose to send this data to the BSC in SDB format. If the BSC determines that short data bursts may be used to deliver the data to the mobile, the BSC may send the data, which may be in SDB format, directly to the mobile over the signaling channel. The BSC may also send this data, in SDB format, to the MSC for delivery to the mobile via the application data delivery service (ADDS) page. The data may be delivered to the MSC using the BSC service request/response procedure. If the BSC is unsuccessful in delivering the SDB data to the mobile on its own, it may choose to send the data to the MSC for delivery to the mobile via the ADDS page procedure.

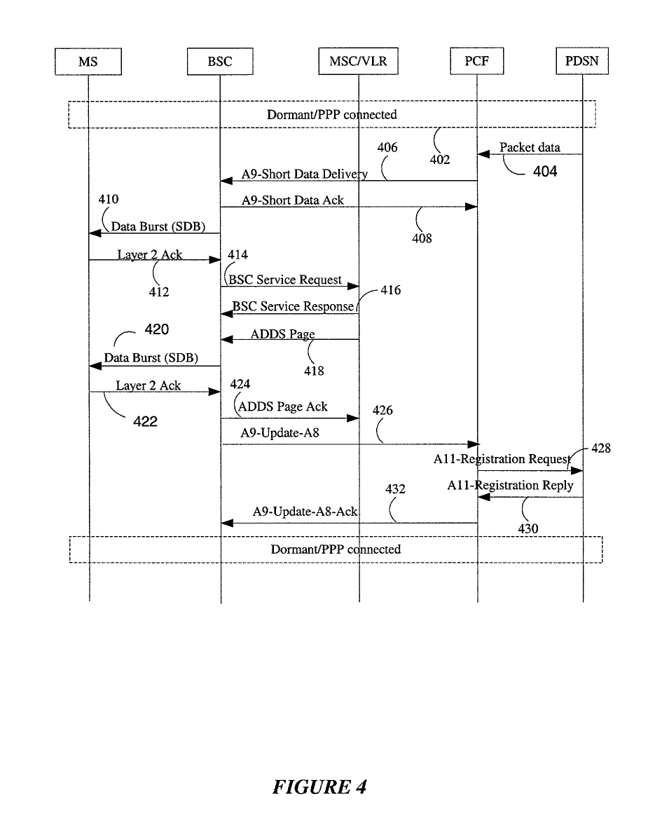

An exemplary call-flow procedure for the mobile-terminated SDB delivery is shown in FIG. 4, as described in IS-2001-A standard.

In one embodiment, the packet data is in the dormant state 402, with PPP connected. The PDSN may send 404 packet data to the PCF on the existing PPP connection, e.g. A10 connection, associated with a specific mobile. The PCF may send 406 the packet data to the BSC, e.g. in short data bursts on an A9 connection. The PCF may also buffer the packet data.

The BSC may acknowledge the receipt of the A9-SDB message from the PCF by returning 408 an, e.g., A9-SDB, acknowledge message, which may include an indication that the BSC may attempt to send the data to the mobile as a SDB. The PCF may then discard the data that it had buffered.

The BSC may send the packet data, e.g., in SDB form, directly to the mobile, or alternatively the BSC may use the ADDS page procedure. The BSC may decide to deliver the data to the mobile over the traffic channel by first bringing up the traffic channel. If the BSC directly sends 410 the SDB to the mobile, the mobile may send 412, e.g., a layer 2, acknowledgement in response to the SDB received from the BSC. If the acknowledgement is not received from the mobile, the BSC may choose not to send the data or may rely on the MSC to deliver the data via ADDS Page procedure.

If the BSC could not successfully send the SDB to the mobile in step 410, the BSC may send 414 the SDB data to the MSC in a BSC service request message. The MSC may acknowledge the reception of the BSC service request message by sending 416 a BSC service response to the BSC. The MSC may send 418 an ADDS Page message to the BSC(s) with the data burst type field in the ADDS user part element set to SDB, and the SDB included in the application data message field. The BSC may forward 420 the SDB to the mobile. An, e.g., layer 2, acknowledgement may be sent 422 by the mobile after receiving the SDB from the BSC.

If the MSC had included a tag element in the ADDS page message, the BSC may return 424 an ADDS page acknowledge message to the MSC after receiving the acknowledge 422 from the mobile. The BSC may send 426 an, e.g., A9-update-A8, message to the PCF to indicate successful transmission of the SDB to the mobile. The PCF may send 428 an, e.g., A11, registration request with the SDB airlink record to the PDSN. The PDSN may respond 430 with an, e.g., A11, registration reply message. The PCF may respond 432 to the BSC with an, e.g., A9, update acknowledge.

Having the BSC directly deliver the SDB to the mobile may minimize the delay, but the mobile may not receive the SDB because it may have moved out of the BSC service area by the time the SDB arrives. Since the MSC maintains mobile location information, ADDS Page ensures that the mobile rseceives the SDB. However, this procedure may incur a larger delay, since the BSC has to send the SDB to the MSC first, and then the MSC sends the SDB to the appropriate BSCs to perform the ADDS Page.

Caching Mobile's Location

In one embodiment, the BSC may cache the mobile's location information, which may be used by the BSC when there is a SDB destined for the mobile and the packet data session is dormant. Using the cached mobile location information eliminates the delay due to MSC's sending the ADDS Page and provides assured delivery of the SDB to the mobile.

In one embodiment, the BSC may obtain the location information of the target mobile from the mobile's response to the page request sent by the MSC. The page response message may include a cell identifier field that specifies the location, e.g., a cell location area code (LAC), of the mobile. In one embodiment, the BSC may obtain the location information from the mobile's registration message. There are several different types of registration defined by the TIA/EIAIIS-2000.5-A, “Upper Layer (Layer 3) Signaling Standard for cdma2000 Spread Spectrum Systems,” dated November 2000, (IS-2000 standard), for example. Any of these registration types may provide the BSC information about the location of the mobile. The BSC may update its cached database if it receives a page response, a registration response, an origination message, or other signaling messages that provide the location information for the mobile.

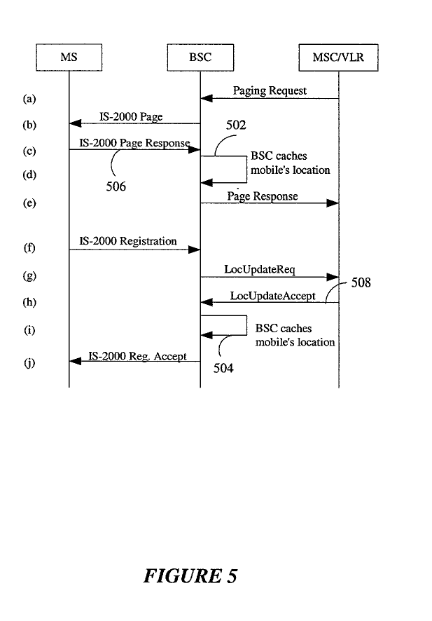

As illustrated in FIG. 5, the BSC may cache 502, 504 the mobile's location information after it receives 506 an, e.g., IS-2000, page response from the mobile or receives 508 the location information update accept message from the MSC. A cache timer may be set according to the frequency of the mobile's location update via the registration message.

Network Configurations

Each PCF in the network may be uniquely identified by system identification/network identification/packet zone identification (SID/NID/PZID). When the mobile moves from one PCF to another PCF, i.e., PCF to PCF handoff, during the dormant packet data session, the mobile may be required to reregister to have the PDSN establish an, e.g., A10/A11, interface with the new PCF and terminate the existing connection with the old PCF.

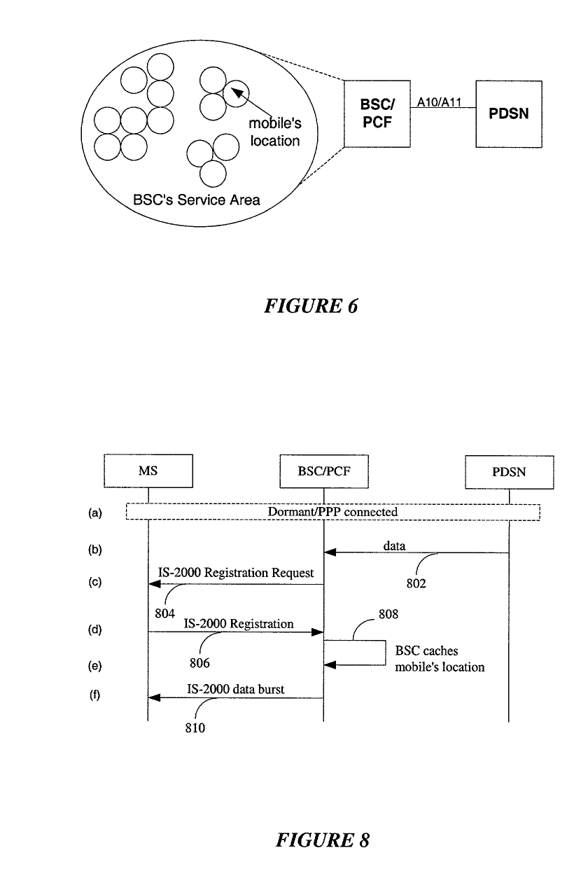

In one embodiment, as shown in FIG. 6, the BSC and the PCF are co-located. When the packet data arrives at the PCF through an, e.g., A10/A11, connection, and the PCF decides to send packet data as a SDB, the mobile may most probably be under the same BSC service area; otherwise, the mobile would have required to re-register and a new, e.g., A10/A11, connection would have been established to a different PCF.

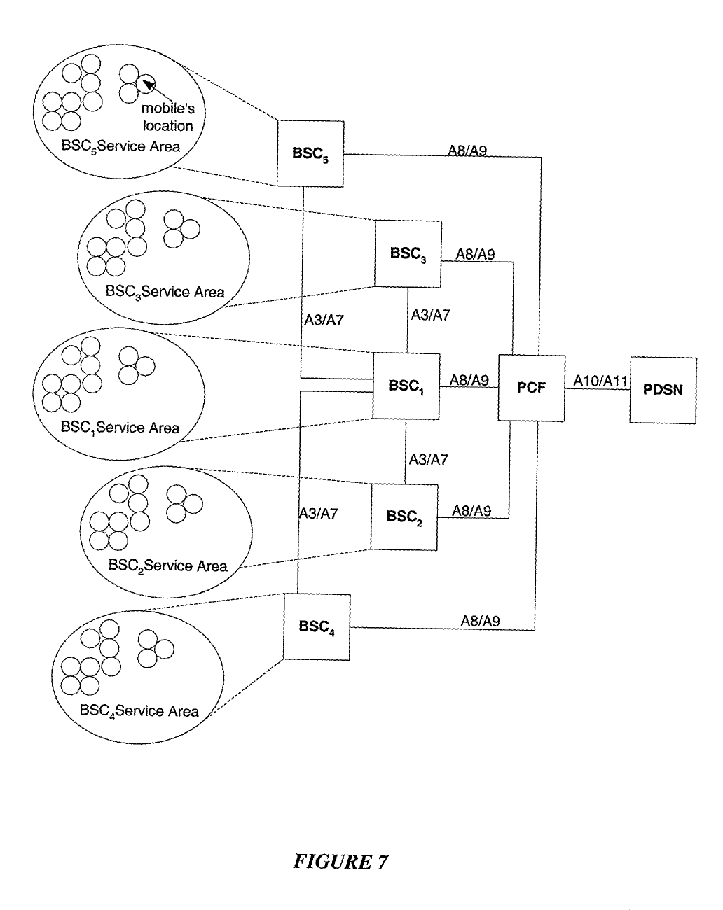

In one embodiment, as shown in FIG. 7, the BSC and the PCF are not co-located. The BSCs and PCF may be interfaced via the A8/A10 connections, for example. The BSCs may interface with each other via the A3/A7 connections, for example. In FIG. 7, BSC₁ is shown to be fully interconnected with other BSCs that are connected to the same PCF. The BSCs that are connected to the same PCF may be interconnected either via point-to-point link or via a switching network. Unlike the scenario where the BSC and the PCF are co-located, when the PCF sends the SDB to the BSC₁, BSC₁ may fail in delivering the SDB to the target mobile because the target mobile may have moved outside the BSC₁ area to another BSC service area. In FIG. 7, for example, the mobile may had been in the BSC₁ before the packet data session goes dormant and may have moved to BSC₅ when the BSC, receives the request from the PCF for SDB delivery.

In a first embodiment, where the PCF may be co-located with the BSC, the PCF/BSC may send the information to target mobiles as a SDB, by broadcasting the SDB to all cells within the BSC's service area. Alternatively, to decrease the air link resource consumption, the BSC may utilize the mobile's location information, which may have been already cached at the BSC, to broadcast the data burst to a subset of cells under its control.

In a second embodiment, where the PCF may be co-located with the BSC, as shown in FIG. 8, upon reception 802 of the packet data from the PDSN, before the BSC/PCF sends the information to a target mobile as a SDB, the BSC/PCF may first buffer the information. The BSCIPCF then sends out 804 a request, e.g. an IS-2000 registration request, a page, or other signaling messages, to all or a subset of the cells under its service area based on the BSC's cached mobile's location information. The mobile with some identification information, such as the matching mobile identification number (MIN) or electronic serial number (ESN), responses to the registration request message by sending 806 a response, e.g., a registration message response or a general page response. The response may provide information of which cell/sector the mobile is located in, which allows the BSC to send the information to the destined cell/sector only. The BSC may cache 808 the mobile's location information before sending 810 the SDB to the target mobile. The cached location information may be refreshed by the next page response, registration response, origination message, or other signaling messages that provide the location information for the mobile, or aged out by a timer.

In a third embodiment, where the PCF may not be co-located with the BSC, after the reception of the PCF request to send the information, e.g., as IS-2000 short data bursts, the BSC may determine if it has cached location information for the target mobile. If the location information is cached, which allows the BSC to perform assured delivery, the BSC may send the SDB as short data bursts to a set of cells according to the cached location information. Alternatively, the BSC may send the SDB received from the PCF to other BSCs, which may be connected to the same PCF, e.g., via the A3/A7 connections. The BSCs that have cached information of the target mobile may deliver the SDB as data bursts to those cells based on the cached location information. The BSCs that have not cached location information may also broadcast the data bursts to all cells under their service areas.

In a fourth embodiment, where the PCF may not be co-located with the BSC, instead of directly sending the information, e.g., as SDB, when the BSC receives the information from another BSC or PCF, the BSC may first buffer the SDB and send out a request, as described above in connection with FIG. 8. After receiving a corresponding response from the mobile, the information, e.g., in data burst, may be sent only to the cell or sector identified in the mobile's registration message. Alternatively, the BSC may utilize the cached information of the mobile location to send the request only to a subset of cells serviced by the BSC.

According to a fifth embodiment, where the PCF may not be co-located with the BSC, the BSC may use a registration request or a general page to improve the bandwidth efficiency. When the BSC receives an ADDS Page message from the MSC, instead of broadcasting the information, e.g., in SDB form, to a set of cells as specified in the MSC ADDS page message, the BSC may first buffer the information and then send out a request, e.g., a registration request, a page, or other signaling messages, as discussed in connection with FIG. 8. After receiving a response, e.g., a registration message response or a general page response, from the mobile, the information may be then sent only to the sector or cell identified by the received response. Alternatively, the BSC may utilize the cached location information of the mobile location to send the request to only a subset of cells serviced by the BSC.

Therefore, disclosed embodiments provide for a significant reduction in the actual total dormancy wakeup time by exchanging call signaling even when the mobiles are dormant and no traffic channel is active. The method and apparatus provides for exchanging the group call signaling through the use of the short data burst (SDB) message signaling.

Although several embodiments of the invention is explained in connection with some exemplary group call services, it is to be understood that the invention is not limited in its application to the details of the construction and the arrangement of the components set forth in the disclosed description or illustrated in the drawings. The invention is capable of being implemented in other embodiments and carried out in various ways, for example, in an instant messaging service or any general wireless data communication applications.

1. A method for delivering information to a dormant target communication device in a wireless communication system including a base station controller (BSC) and a packet control function (PCF), the method comprising:
receiving information at the BSC for transmission to a target communication device; and
broadcasting the information to a plurality of communication devices within a service area of the BSC.

2. The method of claim 1, wherein said broadcasting includes broadcasting the information to the communication devices belonging to a group call.

3. The method of claim 1, wherein the BSC and the PCF are co-located.

4. The method of claim 1, wherein said broadcasting includes transmitting the information on a forward common channel of a wireless network.

5. The method of claim 4, wherein said broadcasting includes transmitting the information on a forward paging channel (F-PCH) of the wireless network.

6. The method of claim 4, wherein said broadcasting includes transmitting the information on a forward common control channel (F-CCCH) of the wireless network.

7. The method of claim 4, wherein said transmitting includes transmitting the information as short data burst (SDB).

8. A computer-readable medium embodying a method for delivering information to a dormant target communication device in a wireless communication system including a base station controller (BSC) and a packet control function (PCF), the method comprising: receiving information at a BSC for transmission to a target communication device; and broadcasting the information to a plurality of communication devices within a service area of the BSC.

9. The computer-readable medium of claim 8, wherein said broadcasting includes broadcasting the information to the communication devices belonging to a group call.

10. The computer-readable medium of claim 8, wherein the BSC and the PCF are co-located.

11. The computer-readable medium of claim 8, wherein said broadcasting includes transmitting the information on a forward common channel of a wireless network.

12. The computer-readable medium of claim 11, wherein said broadcasting includes transmitting the information on a forward paging channel (F-PCH) of the wireless network.

13. The computer-readable medium of claim 11, wherein said broadcasting includes transmitting the information on a forward common control channel (F-CCCH) of the wireless network.

14. The computer-readable medium of claim 11, wherein said transmitting includes transmitting the information as short data burst (SDB).

15. An apparatus for delivering information to a dormant target communication device in a wireless communication system including a base station controller (BSC) and a packet control function (PCF), comprising:
means for receiving information at a BSC for transmission to a target communication device; and
means for broadcasting the information to a plurality of communication devices within a service area of the BSC.

16. The apparatus of claim 15, wherein said means for broadcasting includes means for broadcasting the information to the communication devices belonging to a group call.

17. The apparatus of claim 15, wherein the BSC and the PCF are co-located.

18. The apparatus of claim 15, wherein said means for broadcasting includes means for transmitting the information on a forward common channel of a wireless network.

19. The apparatus of claim 18, wherein said means for broadcasting includes means for transmitting the information on a forward paging channel (F-PCH) of the wireless network.

20. The apparatus of claim 18, wherein said means for broadcasting includes means for transmitting the information on a forward common control channel (F-CCCH) of the wireless network.

21. The apparatus of claim 18, wherein said means for transmitting includes means for transmitting the information as short data burst (SDB).

22. An apparatus for delivering information to a dormant target communication device in a wireless communication system including a base station controller (BSC) and a packet control function (PCF), comprising:
a memory unit;
a receiver;
a transmitter; and
a processor coupled to the memory unit, the receiver, and the transmitter, the processor being capable of:
receiving information at a BSC for transmission to a target communication device; and
broadcasting the information to a plurality of communication devices within a service area of the BSC.

23. The apparatus of claim 22, wherein said broadcasting includes broadcasting the information to the communication devices belonging to a group call.

24. The apparatus of claim 22, wherein the BSC and the PCF are co-located.

25. The apparatus of claim 22, wherein said broadcasting includes transmitting the information on a forward common channel of a wireless network.

26. The apparatus of claim 25, wherein said broadcasting includes transmitting the information on a forward paging channel (F-PCH) of the wireless network.

27. The apparatus of claim 25, wherein said broadcasting includes transmitting the information on a forward common control channel (F-CCCH) of the wireless network.

28. The apparatus of claim 25, wherein said transmitting includes transmitting the information as short data burst (SDB).

29. A method for delivering information to a dormant target communication device in a wireless communication system including a base station controller (BSC) and a packet control function (PCF), the method comprising:
receiving information at the BSC for transmission to a target communication device;
sending a request to a plurality of communication devices within a service area of the BSC;
receiving a response from a communication device in the service area; and
sending the information to the communication device that has responded to the request.

30. The method of claim 29, wherein said sending includes sending the information to the communication devices belonging to a group call.

31. The method of claim 29, wherein the BSC and the PCF are co-located.

32. The method of claim 29, wherein said request includes information identifying the target communication device.

33. The method of claim 32, wherein said response includes location information of the communication device that has responded to the request.

34. The method of claim 33, further including caching the location information.

35. The method of claim 29, further including caching the information before said sending.

36. The method of claim 29, wherein said sending includes transmitting the information on a forward common channel of a wireless network.

37. The method of claim 36, wherein said sending includes transmitting the information on a forward paging channel (F-PCH) of the wireless network.

38. The method of claim 36, wherein said sending includes transmitting the information on a forward common control channel (F-CCCH) of the wireless network.

39. The method of claim 36, wherein said transmitting the information includes transmitting the information as short data burst (SDB).

40. A computer-readable medium embodying a method for delivering information to a dormant target communication device in a wireless communication system including a base station controller (BSC) and a packet control function (PCF), the method comprising:
receiving information at the BSC for transmission to a target communication device;
sending a request to a plurality of communication devices within a service area of the BSC;
receiving a response from a communication device in the service area; and
sending the information to the communication device that has responded to the request.

41. The computer-readable medium of claim 40, wherein said sending includes sending the information to the communication devices belonging to a group call.

42. The computer-readable medium of claim 40, wherein the BSC and the PCF are co-located.

43. The computer-readable medium of claim 40, wherein said request includes information identifying the target communication device.

44. The computer-readable medium of claim 43, wherein said response includes location information of the communication device that has responded to the request.

45. The computer-readable medium of claim 43, the method further including caching the location information.

46. The computer-readable medium of claim 40, the method further including caching the information before said sending.

47. The computer-readable medium of claim 40, wherein said sending includes transmitting the information on a forward common channel of a wireless network.

48. The computer-readable medium of claim 47, wherein said sending includes transmitting the information on a forward paging channel (F-PCH) of the wireless network.

49. The computer-readable medium of claim 47, wherein said sending includes transmitting the information on a forward common control channel (F-CCCH) of the wireless network.

50. The computer-readable medium of claim 47, wherein said transmitting the information includes transmitting the information as short data burst (SDB).

51. An apparatus for delivering information to a dormant target communication device in a wireless communication system including a base station controller (BSC) and a packet control function (PCF), comprising:
means for receiving information at the BSC for transmission to a target communication device;
means for sending a request to a plurality of communication devices within a service area of the BSC;
means for receiving a response from a communication device in the service area; and
means for sending the information to the communication device that has responded to the request.

52. The apparatus of claim 51, wherein said means for sending includes means for sending the information to the communication devices belonging to a group call.

53. The apparatus of claim 51, wherein the BSC and the PCF are co-located.

54. The apparatus of claim 51, wherein said request includes information identifying the target communication device.

55. The apparatus of claim 54, wherein said response includes location information of the communication device that has responded to the request.

56. The apparatus of claim 55, further including means for caching the location information.

57. The apparatus of claim 51, further including means for caching the information before said sending.

58. The apparatus of claim 51, wherein said means for sending includes means for transmitting the information on a forward common channel of a wireless network.

59. The apparatus of claim 58, wherein said means for sending includes means for transmitting the information on a forward paging channel (F-PCH) of the wireless network.

60. The apparatus of claim 58, wherein said means for sending includes means for transmitting the information on a forward common control channel (F-CCCH) of the wireless network.

61. The apparatus of claim 58, wherein said means for transmitting includes means for transmitting the information as short data burst (SDB).

62. An apparatus for delivering information to a dormant target communication device in a wireless communication system including a base station controller (BSC) and a packet control function (PCF), comprising:
a memory unit;
a receiver;
a transmitter; and
a processor coupled to the memory unit, the receiver, and the transmitter, the processor being capable of:
receiving information at the BSC for transmission to a target communication device;
sending a request to a plurality of communication devices within a service area of the BSC;
receiving a response from a communication device in the service area; and
sending the information to the communication device that has responded to the request.

63. The apparatus of claim 62, wherein said broadcasting includes broadcasting the information to the communication devices belonging to a group call.

64. The apparatus of claim 62, wherein the BSC and the PCF are co-located.

65. The apparatus of claim 62, wherein said request includes information identifying the target communication device.

66. The apparatus of claim 65, wherein said response includes location information of the communication device that has responded to the request.

67. The apparatus of claim 66, wherein the processor further is capable of caching the location information.

68. The apparatus of claim 62, wherein the processor further is capable of caching the information before said sending.

69. The apparatus of claim 62, wherein said sending includes transmitting the information on a forward common channel of a wireless network.

70. The apparatus of claim 69, wherein said sending includes transmitting the information on a forward paging channel (F-PCH) of the wireless network.

71. The apparatus of claim 69, wherein said sending includes transmitting the information on a forward common control channel (F-CCCH) of the wireless network.

72. The apparatus of claim 69, wherein said transmitting includes transmitting the information as short data burst (SDB).

73. A method for delivering information to a dormant target communication device in a wireless communication system including a plurality of a base station controllers (BSCs) in communication with a packet control function (PCF), the method comprising:
receiving a request at one of the plurality of BSCs to send information to a target communication device;
determining if the BSC has location information about the target communication device; and
transmitting the information to the target communication device if the BSC has the location information.

74. The method of claim 73, further including transmitting the information to other BSCs if said BSC does not have location information for the target communication device so that one of the other BSCs that has location information for the target communication device transmits the information to the target communication device.

75. The method of claim 74, further including broadcasting the information to all communication devices if none of the BSCs has location information for the target communication device.

76. The method of claim 73, wherein the BSCs and the PCF are not co-located.

77. The method of claim 73, wherein said transmitting includes transmitting on a forward common channel of a wireless network.

78. The method of claim 77, wherein said transmitting includes transmitting on a forward paging channel (F-PCH) of the wireless network.

79. The method of claim 77, wherein said transmitting includes transmitting on a forward common control channel (F-CCCH) of the wireless network.

80. The method of claim 77, wherein said transmitting the information includes transmitting the information as short data burst (SDB).

81. A computer-readable medium embodying a method for delivering information to a dormant target communication device in a wireless communication system including a plurality of a base station controllers (BSCs) in communication with a packet control function (PCF), the method comprising:
receiving a request at one of the plurality of BSCs to send information to a target communication device;
determining if the BSC has location information about the target communication device; and
transmitting the information to the target communication device if the BSC has the location information.

82. The computer-readable medium of claim 81, further including transmitting the information to other BSCs if said BSC does not have location information for the target communication device so that one of the other BSCs that has location information for the target communication device transmits the information to the target communication device.

83. The computer-readable medium of claim 82, the method further including broadcasting the information to all communication devices if none of the BSCs has location information for the target communication device.

84. The computer-readable medium of claim 81, wherein the BSCs and the PCF are not co-located.

85. The computer-readable medium of claim 81, wherein said transmitting includes transmitting on a forward common channel of a wireless network.

86. The computer-readable medium of claim 85, wherein said transmitting includes transmitting on a forward paging channel (F-PCH) of the wireless network.

87. The computer-readable medium of claim 85, wherein said transmitting includes transmitting on a forward common control channel (F-CCCH) of the wireless network.

88. The computer-readable medium of claim 85, wherein said transmitting includes transmitting the information as short data burst (SDB).

89. An apparatus for delivering information to a dormant target communication device in a wireless communication system including a plurality of a base station controllers (BSCs) in communication with a packet control function (PCF), comprising:
means for receiving a request at one of the plurality of BSCs to send information to a target communication device;
means for determining if the BSC has location information about the target communication device; and
means for transmitting the information to the target communication device if the BSC has the location information.

90. The apparatus of claim 90, further including means for transmitting the information to other BSCs if said BSC does not have location information for the target communication device so that one of the other BSCs that has location information for the target communication device transmits the information to the target communication device.

91. The apparatus of claim 89, further including means for broadcasting the information to all communication devices if none of the BSCs has location information for the target communication device.

92. The apparatus of claim 89, wherein the BSCs and the PCF are not co-located.

93. The apparatus of claim 89, wherein said means for transmitting transmits the information on a forward common channel of a wireless network.

94. The apparatus of claim 93, wherein said means for transmitting transmits the information on a forward paging channel (F-PCH) of the wireless network.

95. The apparatus of claim 93, wherein said means for transmitting transmits the information on a forward common control channel (F-CCCH) of the wireless network.

96. The apparatus of claim 93, wherein said means for transmitting transmits the information as short data burst (SDB).

97. An apparatus for delivering information to a dormant target communication device in a wireless communication system including a plurality of a base station controllers (BSCs) in communication with a packet control function (PCF), comprising:
a memory unit;
a receiver;
a transmitter; and
a processor coupled to the memory unit, the receiver, and the transmitter, the processor being capable of:
receiving a request at one of the plurality of BSCs to send information to a target communication device;
determining if the BSC has location information about the target communication device; and
transmitting the information to the target communication device if the BSC has the location information.

98. The apparatus of claim 97, the processor further being capable of transmitting the information to other BSCs if said BSC does not have location information for the target communication device so that one of the other BSCs that has location information for the target communication device transmits the information to the target communication device.

99. The apparatus of claim 98, the processor further being capable of broadcasting the information to all communication devices if none of the BSCs has location information for the target communication device.

100. The apparatus of claim 97, wherein the BSCs and the PCF are not co-located.

101. The apparatus of claim 97, wherein said transmitting includes transmitting on a forward common channel of a wireless network.

102. The apparatus of claim 101, wherein said transmitting includes transmitting on a forward paging channel (F-PCH) of the wireless network.

103. The apparatus of claim 101, wherein said transmitting includes transmitting on a forward common control channel (F-CCCH) of the wireless network.

104. The apparatus of claim 101, wherein said transmitting includes transmitting the information as short data burst (SDB).

105. A method for delivering information to a dormant target communication device in a wireless communication system including a mobile station controller (MSC) and a plurality of base station controllers (BSCs) in communication with a packet control function (PCF), the method comprising:
receiving an application data delivery service (ADDS) page at one of the plurality of BSCs for transmitting information to the target communication device;
buffering the information at the BSC;
sending a request to the communication device;
receiving a response from the target communication device; and
sending the information to the target communication device.

106. The method of claim 105, wherein said sending the request includes sending a registration request, and said receiving the response includes receiving a registration response.

107. The method of claim 105, wherein said sending the request includes sending a general page, and said receiving the response includes receiving a general page response.

108. The method of claim 105, wherein the response includes location information of the target communication device.

109. The method of claim 108, further including caching the location information of the target communication device.

110. The method of claim 105, wherein the BSCs and the PCF are not co-located.

111. The method of claim 105, wherein said sending includes transmitting the information on a forward common channel of a wireless network.

112. The method of claim 110, wherein said sending includes transmitting the information on a forward paging channel (F-PCH) of the wireless network.

113. The method of claim 110, wherein said sending includes transmitting the information on a forward common control channel (F-CCCH) of the wireless network.

114. The method of claim 110, wherein said sending includes transmitting the information as short data burst (SDB).

115. A computer-readable medium embodying a method for delivering information to a dormant target communication device in a wireless communication system including a mobile station controller (MSC) and a plurality of base station controllers (BSCs) in communication with a packet control function (PCF), the method comprising:
receiving an application data delivery service (ADDS) page at one of the plurality of BSCs for transmitting information to the target communication device;
buffering the information at the BSC;
sending a request to the communication device;
receiving a response from the target communication device; and
sending the information to the target communication device.

116. The computer-readable medium of claim 115, wherein said sending the request includes sending a registration request, and said receiving the response includes receiving a registration response.

117. The computer-readable medium of claim 115, wherein said sending the request includes sending a general page, and said receiving the response includes receiving a general page response.

118. The computer-readable medium of claim 115, wherein the response includes location information of the target communication device.

119. The computer-readable medium of claim 118, further including caching the location information of the target communication device.

120. The method of claim 115, wherein the BSCs and the PCF are not co-located.

121. The computer-readable medium of claim 115, wherein said sending includes transmitting the information on a forward common channel of a wireless network.

122. The computer-readable medium of claim 121, wherein said sending includes transmitting the information on a forward paging channel (F-PCH) of the wireless network.

123. The computer-readable medium of claim 121, wherein said sending includes transmitting the information on a forward common control channel (F-CCCH) of the wireless network.

124. The computer-readable medium of claim 121, wherein said sending includes transmitting the information as short data burst (SDB).

125. An apparatus for delivering information to a dormant target communication device in a wireless communication system including a mobile station controller (MSC) and a plurality of base station controllers (BSCs) in communication with a packet control function (PCF), comprising:
means for receiving an application data delivery service (ADDS) page at one of the plurality of BSCs for transmitting information to the target communication device;
means for buffering the information at the BSC;
means for sending a request to the communication device;
means for receiving a response from the target communication device; and
means for sending the information to the target communication device.

126. The apparatus of claim 125, wherein said means for sending the request includes means for sending a registration request, and said means for receiving the response includes means for receiving a registration response.

127. The computer-readable medium of claim 125, wherein said means for sending the request includes means for sending a general page, and said means for receiving the response includes means for receiving a general page response.

128. The apparatus of claim 125, wherein the response includes location information of the target communication device.

129. The apparatus of claim 128, further including means for caching the location information of the target communication device.

130. The apparatus of claim 125, wherein the BSCs and the PCF are not co-located.

131. The apparatus of claim 125, wherein said means for sending transmits the information on a forward common channel of a wireless network.

132. The apparatus of claim 131, wherein said means for sending transmits the information on a forward paging channel (F-PCH) of the wireless network.

133. The apparatus of claim 131, wherein said means for sending transmits the information on a forward common control channel (F-CCCH) of the wireless network.

134. The apparatus of claim 131, wherein said means for sending transmits the information as short data burst (SDB).

135. An apparatus for delivering information to a dormant target communication device in a wireless communication system including a mobile station controller (MSC) and a plurality of base station controllers (BSCs) in communication with a packet control function (PCF), comprising:
a memory unit;
a receiver;
a transmitter; and
a processor coupled to the memory unit, the receiver, and the transmitter, the processor being capable of:
receiving an application data delivery service (ADDS) page at one of the plurality of BSCs for transmitting information to the target communication device;
buffering the information at the BSC;
sending a request to the communication device;
receiving a response from the target communication device; and
sending the information to the target communication device.

136. The apparatus of claim 135, wherein said sending the request includes sending a registration request, and said receiving the response includes receiving a registration response.

137. The computer-readable medium of claim 135, wherein said sending the request includes sending a general page, and said receiving the response includes receiving a general page response.

138. The apparatus of claim 135, wherein the response includes location information of the target communication device.

139. The apparatus of claim 138, the processor further being capable of caching the location information of the target communication device.

140. The apparatus of claim 139, wherein the BSCs and the PCF are not co-located.

141. The apparatus of claim 139, wherein said sending includes transmitting the information on a forward common channel of a wireless network.

142. The apparatus of claim 141, wherein said sending includes transmitting the information on a forward paging channel (F-PCH) of the wireless network.

143. The apparatus of claim 141, wherein said sending includes transmitting the information on a forward common control channel (F-CCCH) of the wireless network.

144. The apparatus of claim 141, wherein said sending includes transmitting the information as short data burst (SDB).
